(19) United States
(12) Patent Application Publication
(10) Pub. No.: US 2023/0317043 A1
(43) Pub. Date: Oct. 5, 2023

(54) AUDIO DEVICE SIMULATION METHOD, AUDIO DEVICE SIMULATOR, AND AUDIO DEVICE SIMULATION SYSTEM

(71) Applicant: Yamaha Corporation, Hamamatsu (JP)

(72) Inventors: Kazunobu KONDO, Toyohashi (JP); Yoshifumi MIZUNO, Hamamatsu (JP); Yoshihiko KAWASHIMA, Hamamatsu (JP); Hayato OHSHITA, Hamamatsu (JP)

(21) Appl. No.: 18/329,950

(22) Filed: Jun. 6, 2023

Related U.S. Application Data
(63) Continuation of application No. PCT/JP20/46308, filed on Dec. 11, 2020.

(51) Int. Cl. G10H 5/00

(52) U.S. Cl. CPC G10H 5/007; G10H 2250/511

(57) ABSTRACT

An audio device simulation method includes acquiring a standard model that models input-output characteristics of an audio device, and setting at least one parameter of a target audio device of the same type as the audio device and measuring input-output characteristics of the target audio device, and generating an individual model that models input-output characteristics of the target audio device by correcting the standard model using measured input-output characteristics that have been measured.

### CROSS-REFERENCE TO RELATED APPLICATIONS

This application is a continuation application of International Application No. PCT/JP2020/046308, filed on Dec. 11, 2020. The entire disclosures of International Application No. PCT/JP2020/046308 are hereby incorporated herein by reference.

### BACKGROUND

### Technological Field

This disclosure relates to an audio device simulation method, an audio device simulator, and an audio device simulation system.

### Background Information

Japanese Laid-Open Patent Publication No. 2006-94153 discloses an analog audio device simulator that can change the amount of harmonic distortion generated in accordance with frequency for each harmonic order.

### SUMMARY

Due to their individual characteristics, analog audio devices output sound with different tones, even if they are of the same type. Thus, even if an audio device is modeled, the model will be different from the sound of other audio devices of the same type.

One embodiment of this disclosure relates to an audio device simulation method, an audio device simulator, and an audio device simulation system that can model the unique sound of each device.

An audio device simulation method according to one aspect of this disclosure comprises acquiring a standard model that models input-output characteristics of an audio device, and setting at least one parameter of a target audio device of the same type as the audio device and measuring input-output characteristics of the target audio device, and generating an individual model that models input-output characteristics of the target audio device by correcting the standard model using measured input-output characteristics that have been measured.

An audio device simulator according to yet another aspect of this disclosure comprises at least one processor configured to acquire a standard model that models input-output characteristics of an audio device, measure input-output characteristics of a target audio device of the same type as the audio device, for one or more parameters of the target audio device, and generate an individual model that models input-output characteristics of the target audio device, by correcting the standard model using measured input-output characteristics that have been measured.

An audio device simulation system according to another aspect of this disclosure comprising an audio device simulator and a measurement device. The audio device simulator is configured to acquire a standard model that models input-output characteristics of an audio device. The measurement device includes at least one processor configured to set at least one parameter of a target audio device of the same type as the audio device and measure input-output characteristics of the target audio device. The audio device simulator is further configured to generate an individual model that models input-output characteristics of the target audio device, by correcting the standard model using measured input-output characteristics that have been measured.

### BRIEF DESCRIPTION OF THE DRAWINGS

FIG. 1 is a block diagram showing a configuration of a simulation system.

FIG. 2 is a schematic diagram of an external view when a measuring device is attached to an analog audio device.

FIG. 3 is a block diagram showing a configuration of the measuring device.

FIG. 4 is a block diagram showing a configuration of an information processing terminal.

FIG. 5 is a flowchart showing operations of the information processing terminal, a server, and the measuring device.

FIG. 6A is a conceptual diagram showing a signal processing block of a standard model.

FIG. 6B is a conceptual diagram showing a signal processing block of an individual model.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

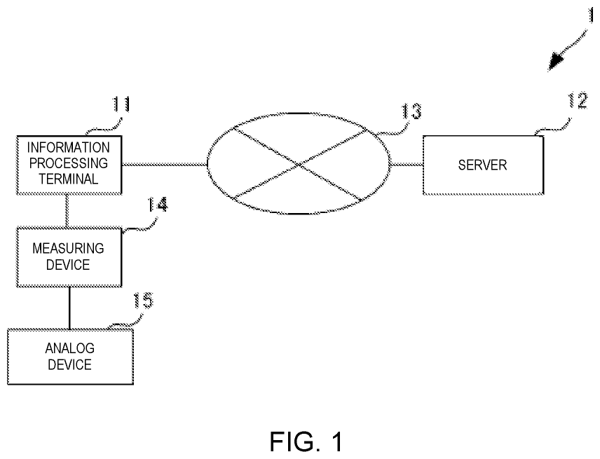

FIG. 1 is a block diagram showing a configuration of an audio device simulation system 1. The audio device simulation system 1 according to this embodiment includes an information processing terminal 11, a server 12, a measuring device 14, and an analog audio device 15. The information processing terminal 11 is connected to the server 12 via the Internet 13.

The information processing terminal 11 is an information processing device such as a personal computer or a smartphone used by a user. The analog audio device 15 is an analog amplifier or an analog effector, for example. The user attaches the measuring device 14 to the analog audio device 15. The measuring device 14 measures the input-output characteristics of the analog audio device 15.

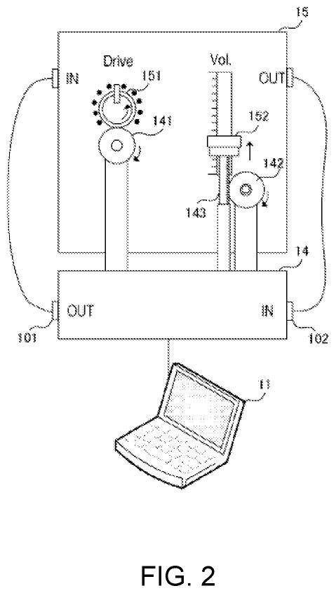

FIG. 2 is a schematic diagram of the external appearance when the measuring device 14 is attached to the analog audio device 15. The analog audio device 15 of this example is an analog effector that distorts sound signals. The analog audio device 15 includes an input terminal (IN), and output terminal (OUT), and an operator, such as a knob 151 and a slider 152, which receives one or more changes to one or more parameters. The input terminal and the output terminal are analog audio terminals. In this example, the knob 151 corresponds to the distortion intensity parameter (Drive). The slider 152 corresponds to the volume parameter (Vol.).

The measuring device 14 includes an output terminal (OUT) 101, an input terminal (IN) 102, a motor such as a servo motor 141 and a servo motor 142, and a rack 143. The measuring device 14 outputs analog sound signals to an input terminal of the analog audio device 15 via the output terminal 101. The measuring device 14 inputs analog sound signals from an output terminal of the analog audio device 15 via the input terminal 102.

The servo motor 141 is attached to the knob 151. The servo motor 141 rotates the knob 151 to adjust the distortion parameter to a desired value. The servo motor 142 is attached to the slider 152 via the rack 143. The servo motor 142 has a pinion gear. The servo motor 142 moves the rack 143 linearly via the pinion gear. The servo motor 142 moves the slider 152 via the rack 143 to adjust the volume parameter to a desired value. The motor 142 can also move the slider 152 by converting rotary motion into linear motion by a crank mechanism.

The information processing terminal 11 is connected to the measuring device 14 via a communication line, such as a USB (Universal Serial Bus). The information processing terminal 11 transmits a measurement signal to the measuring device 14. The information processing terminal 11 inputs a sound signal for measurement to the analog audio device 15 via the measuring device 14 and receives a sound signal after signal processing. The information processing terminal 11 measures the input-output characteristics of the analog audio device 15 based on the sound signal transmitted to the measuring device 14 and the received sound signal after signal processing.

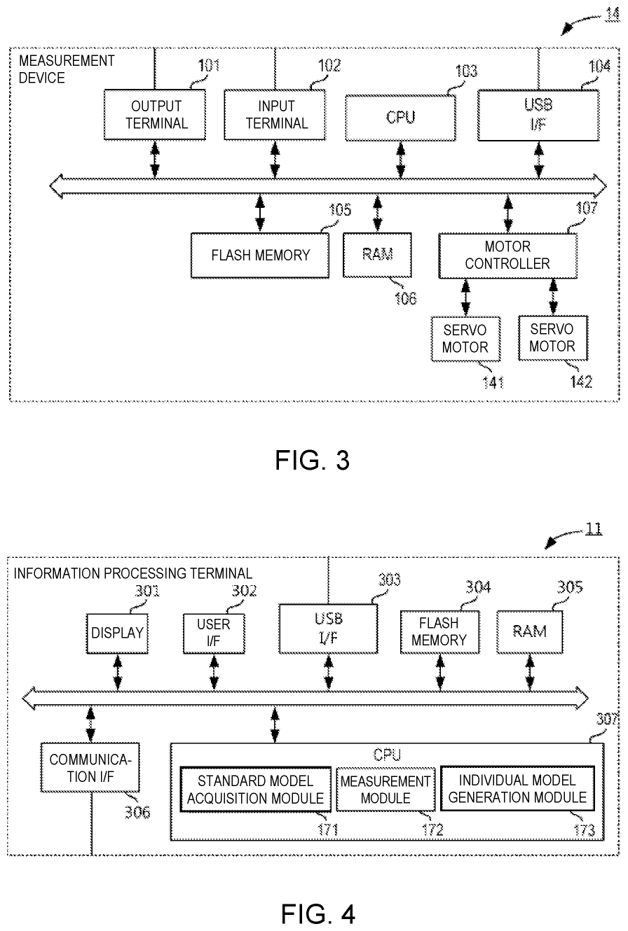

FIG. 3 is a block diagram showing a configuration of the measuring device 14. The measuring device 14 includes the output terminal 101, the input terminal 102, a CPU (Central Processing Unit) 103, a USB I/F (Interface) 104, a flash memory 105, a RAM (Random Access Memory) 106, a motor controller 107, the servo motor 141 and the servo motor 142.

The CPU 103 is one example of at least one processor as an electronic controller (control unit) that controls the operation of the measuring device 14. Here, the term “electronic controller” as used herein refers to hardware, and does not include a human. The measuring device 14 can include, instead of the CPU 103 or in addition to the CPU 103, one or more types of processors, such as a GPU (Graphics Processing Unit), a DSP (Digital Signal Processor), an FPGA (Field Programmable Gate Array), an ASIC (Application Specific Integrated Circuit), and the like. The CPU 103 reads a prescribed program stored in the flash memory 105, which is a storage medium (computer memory), into the RAM 106 to perform various operations. For example, the CPU 103 controls the servo motor 141 and the servo motor 142 via the motor controller 107 to adjust the parameters of the analog audio device 15 to desired values.

The USB I/F 104 is connected to the information processing terminal 11. The USB I/F 104 receives a first digital sound signal from the information processing terminal 11. The first digital sound signal is a sound signal for measurement. The sound signal for measurement is a measurement signal such as white noise, a TSP (Time Stretched Pulse), or a tone burst. The sound signal for measurement can also be a music signal.

The CPU 103 converts the first digital sound signal into a first analog signal and outputs it to the analog audio device 15 via the output terminal 101. The CPU 103 receives a second analog sound signal from the analog audio device 15 via the input terminal 102. The CPU 103 converts the received second analog sound signal into a second digital sound signal. The CPU 103 transmits the second digital sound signal to the information processing terminal 11 via the USB I/F 104.

FIG. 4 is a block diagram showing a configuration of the information processing terminal 11. The information processing terminal 11 includes a display (display unit) 301, a user I/F (Interface) 302, a USB I/F (Universal Serial Bus Interface) 303, a flash memory 304, a RAM (Random Access Memory) 305, a communication I/F (Interface) 306, and a CPU (Central Processing Unit) 307.

The display 301 displays various types of information to the user and can be configured from, for example, a liquid-crystal display or an organic electroluminescent display. The user I/F 302 receives operations from the user. The user I/F 302 can be laminated to the display 301 as a touch panel. The USB I/F 303 transmits the first digital sound signal to the measuring device 14. The USB I/F 303 also receives the second digital sound signal from the measuring device 14. The communication I/F 306 communicates with the server 12 via a network.

The CPU 307 reads a program stored in the flash memory 304, which is a storage medium (computer memory), into the RAM 305, to realize prescribed functions. The CPU 307 is one example of at least one processor as an electronic controller of the information processing terminal 11. Here, the term “electronic controller” as used herein refers to hardware, and does not include a human. The information processing terminal 11 can include, instead of the CPU 307 or in addition to the CPU 307, one or more types of processors, such as a GPU (Graphics Processing Unit), a DSP (Digital Signal Processor), an FPGA (Field Programmable Gate Array), an ASIC (Application Specific Integrated Circuit), and the like. As shown in FIG. 4, the CPU 307 functionally configures and executes a standard model acquisition module 171, a measurement module 172, and an individual model generation module 173. These configurations are realized as functional configurations of the application program that is read by the CPU 307. The standard model acquisition module 171 acquires the standard model 900 from the server 12. The measurement module 172 measures the input-output characteristics of the analog audio device 15 via the measuring device 14. The individual model generation module 173 generates an individual model that models the input-output characteristics of the analog audio device 15.

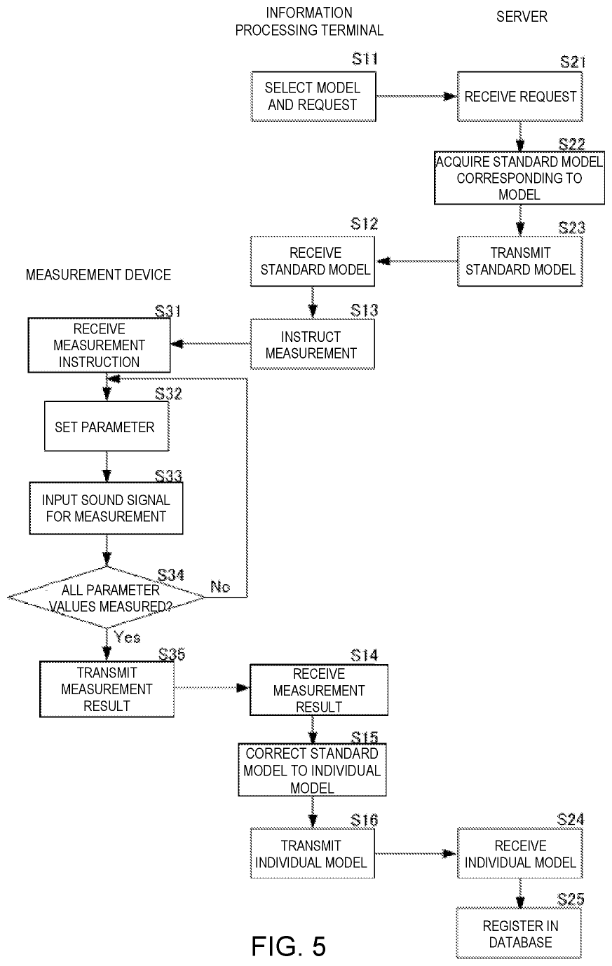

FIG. 5 is a flowchart showing operations of the information processing terminal 11, the server 12, and the measuring device 14. First, the user selects the model of the analog audio device 15 via the user I/F 302 of the information processing terminal 11 and makes a measurement request (S11). For example, the CPU 307 displays a list of the amplifier model names on the display 301 by an application program. The user selects his or her own model from the displayed list. Alternatively, the CPU 307 can display the names of typical effectors, such as distortion, equalizer, compressor, etc., on the display 301. The user selects the name of the effector that he or she is using from the displayed effector names.

The server 12 receives the request (S21). The server 12 acquires the standard model 900 corresponding to the information indicating the model included in the request (S22). The standard model 900 is a model in which the standard input-output characteristics of a particular analog audio device are modeled using digital signal processing blocks.

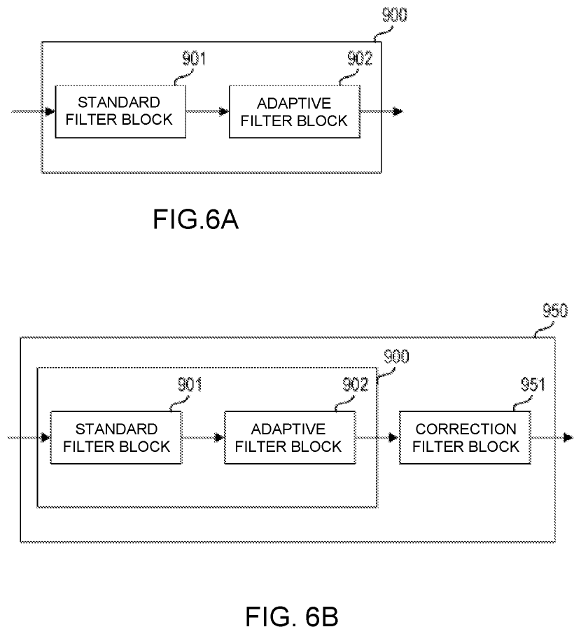

FIG. 6A is a conceptual diagram showing a signal processing block of the standard model 900. The standard model 900 has a standard filter block 901 and an adaptive filter block 902. The standard filter block 901 and the adaptive filter block 902 are signal processing blocks that respectively simulate the electronic characteristics of an analog circuit (a circuit composed of electronic components such as resistors, diodes, capacitors, vacuum tubes, inductors, etc.) using digital filters. In FIG. 6A, for simplicity of explanation, an example is shown in which only one standard filter block 901 and one adaptive filter block 902 connected in series are shown. However, the standard model 900 is actually a digital filter circuit with numerous signal processing blocks and various modes of connection.

These signal processing blocks are prepared in advance by an analog audio device manufacturer by simulating the electronic characteristics of an actual analog circuit. Alternatively, the standard model can be prepared by measuring the input-output characteristics (for example, the impulse response) of an analog audio device under a plurality of measurement conditions. Such a standard model is stored in a database on the server 12.

The standard filter block 901 is a digital filter that is independent of changes in the parameters of the knobs, sliders, etc., of the analog audio device, and includes, for example, an envelope extraction filter (envelope follower). The adaptive filter block 902 is a digital filter in which the filter coefficients change in response to changes in the parameters of the analog audio device. The standard filter block 901 and the adaptive filter block 902 can be nonlinear or linear filters.

The server 12 transmits the standard model 900 acquired from the database (S23) to the information processing terminal 11. The information processing terminal 11 receives the standard model 900 (S12). The standard model acquisition module 171 of the information processing terminal 11 thereby acquires the standard model 900.

The measurement module 172 of the information processing terminal 11 sends a sound signal for measurement to the measuring device 14 and instructs the measuring device 14 to make a measurement (S13). When the measurement instruction is received (S31), the measuring device 14 sets the parameters of the analog audio device 15 (S32).

The measuring device 14 (CPU103) sets, as the reference values, the values of the knob 151 and the slider 152 when the measuring device 14 is attached to the analog audio device 15. For example, the user sets the parameter values to the most frequently used parameter values, and then attaches the measuring device 14 and instructs the measuring device 14 to start the measurement via the user I/F 302 of the information processing terminal 11.

The measuring device 14 (CPU103) measures input-output characteristics of analog audio device 15. More specifically, the measuring device 14 inputs the sound signal for measurement to the analog audio device 15 and receives the sound signal after signal processing from the analog audio device 15 (S33). The sound signal for measurement is, for example, a measurement signal such as white noise or a music signal, in the same manner as described above. In the case of a measurement signal, for example, a measurement is made for each of a plurality of measurement signals having different levels. In the case of a music signal, for example, a measurement is made for each of a plurality of music signals with different contents.

The measurement device 14 determines whether measurements have been made for all the parameter values of the analog audio device 15 (S34). If measurements have not been made for all the parameter values, process control returns to Step S32 and the parameters are set.

The measuring device 14, by controlling the servo motors 141 and 142, can set each parameter of the analog audio device 15 sequentially from the minimum value to the maximum value, at the minimum resolution. The relationship between the rotational positions of the servo motors 141 and 142, the rotational position of the knob 151, and the slider position of the slider 152 is determined in the following manner, for example.

The audio device manufacturer registers, in a database on the server 12, information such as the minimum value, the maximum value, the resolution, etc., of Drive and Vol. The information processing terminal 11 acquires information, such as the minimum value, the maximum value, and the resolution of the Drive and Vol. from the server 12. Alternatively, for example, the user can input information such as the minimum value, the maximum value, and the resolution of the Drive via the user I/F 302 of the information processing terminal 11. Also, for example, the user can use a camera (not shown) of the information processing terminal 11 to photograph the knob 151 and the slider 152. The information processing terminal 11 can also recognize the maximum values, the minimum values, the resolutions, and the current positions of the knob 151 and the slider 152 by image processing.

The measuring device 14 receives information, such as the minimum value, maximum value, and the resolution of each parameter, from the information processing terminal 11. The measuring device 14 rotates the servo motor 141 left and right, associates the stop position of a right rotation with the minimum value, and associates the stop position of a left rotation with the maximum value. Similarly, the measuring device 14 rotates the servo motor 142 left and right, associates the stop position of a right rotation with the minimum value, and associates the stop position of a left rotation with the maximum value. The measuring device 14 then associates the resolution information with the rotation angle. The measuring device 14 can thus rotate the servo motors 141 and 142 to set each parameter value, from the minimum value to the maximum value, at the minimum resolution.

Further, for example, the user can use a camera (not shown) of the information processing terminal 11 to photograph the knob 151 and the slider 152 in a state in which the measuring device 14 is attached. The information processing terminal 11 recognizes the maximum values, the minimum values, the resolutions, and the current positions of the knob 151 and the slider 152 by image processing. The measuring device 14 acquires the maximum values, the minimum values, the resolutions, and the current positions of the knob 151 and the slider 152, from the information processing terminal 11, and determines the relationship between the rotation angles of the servo motors 141, 142 and the positions of the knob 151 and the slider 152.

The parameter values can be changed manually by the user. After the measurement with a certain parameter values is completed, the information processing terminal 11 displays a prompt to change the parameter value on the display 301. The user operates the knob 151 or the slider 152 to change the parameter value. The user can then operate the user I/F 302 of the information processing terminal 11 to issue measurement instructions for the next parameter value. Alternatively, the information processing terminal 11 can display a guide for the next parameter value superimposed on an image of the knob 151 and the slider 152 photographed with a camera (not shown).

The measuring device 14 repeats the measurement, for each parameter value, using a plurality of measurement signals of different volume or a plurality of different types of music signals. When the measuring device 14 determines that measurements have been carried out for all parameter values, the measuring device 14 transmits the sound signal (measurement result) received from the analog audio device 15 to the information processing terminal 11 (S35). However, the measurement results need not be transmitted after measurements have been made after measurements for all parameter values. The measurement results can, for example, be transmitted sequentially after a measurement is made using a certain measurement signal or music signal.

The information processing terminal 11 receives the measurement results (S14). The individual model generation module 173 of the information processing terminal 11 by correcting the standard model based on the measurement result, generates an individual model that models the input-output characteristics of the analog audio device 15 (S15).

The individual model is obtained by correcting a standard model so as to represent the input-output characteristics of the target audio device (analog audio device 15) for which the measurement was made. As shown in FIG. 6B, the individual model 950 is, for example, one in which the output of the standard model 900 is corrected by a correction filter block 951. The individual model generation module 173 calculates, for each of a plurality of sound signals for measurements having different volumes, the difference between the output result when input to the individual model 950 and the measurement result when measured via the measuring device 14, and sets the filter coefficients that minimize this difference in the correction filter block 951. As a result, the correction filter block 951 expresses the frequency characteristic that depends on volume. The input-output characteristics of the analog audio device 15 change nonlinearly with changes in the parameters. The correction filter block 951 is provided for each value of each combination of the plurality of parameters (knob 151 and slider 152) of the analog audio device 15. Therefore, the correction filter block 951 is a filter that corrects the difference of the input-output characteristics between the standard model 900 and the analog audio device 15.

Alternatively, the individual model generation module 173 can correct the output of the standard model 900 by correcting the filter coefficients of the adaptive filter block 902 shown in FIG. 6A and use the corrected standard model 900 as the individual model 950. In this case, the correction filter block 951 is unnecessary. The individual model generation module 173 calculates, for each of a plurality of sound signals for measurements having different volumes, the difference between the output result when input to the individual model 950 and the result when measured via the measuring device 14. The individual model generation module 173 calculates the filter coefficients that minimize this difference by a prescribed adaptive algorithm and corrects the filter coefficients of the adaptive filter block 902.

The individual model generation module 173 thus generates the individual model 950 that represents the unique sounds of the analog audio device 15 owned by the user.

The information processing terminal 11 transmits the generated individual model 950 to the server 12 (S16). The server 12 receives the individual model 950 (S24), which is then registered in a database (S25).

The user can use an information processing device, such as the information processing terminal 11, to download and use the individual model 950 registered in the database of the server 12 at any time. This allows the user to use virtual amplifiers and effectors having the same input-output characteristics as the analog audio device 15 wherever and whenever necessary without their having to carry the analog audio device 15.

The standard and individual models can be filters using prescribed algorithms such as deep neural networks (hereafter referred to as DNNs). The DNN filters are constructed in advance. For example, the audio device manufacturer inputs a large number of music signals of different types into a standard audio device as sound signals for measurement, and uses the output signals as correct answers to perform deep learning of the input-output characteristics of the audio device.

The audio device manufacturer first fixes the parameters, inputs a large number of music signals of different types, and carries out deep learning of the input-output characteristics of the audio device. Then, when changing the parameter values, the audio device manufacturer performs constrained deep learning which restricts the learning of filter processing blocks that are not affected by parameter changes. In this way, the audio device manufacturer generates a standard model using DNN.

As shown in FIG. 6B, the individual model generation module 173 trains the correction filter block 951, which corrects the output of the standard model 900. In this case, the correction filter block 951 is also a DNN filter. The individual model generation module 173 generates the individual model 950 by deep learning the correction filter block 951 with DNN. The individual model generation module 173 determines the difference between the output result when a plurality of types of music signals are input to the individual model 950, and the result of measurement when measured via the measuring device 14, to make the correction filter block 951 learn so that the difference is minimized. When learning by DNN is performed, it is preferable to input a large number of music signals of different types and cause the measurement results to be learned as the correct answers. However, since the learning of the correction filter block 951 is a process of correcting the standard model 900 to the individual model 950, the computational load is significantly lower than that of learning when the standard model 900 is generated.

Alternatively, the individual model generation module 173 can correct the output of the standard model 900 by causing the adaptive filter block 902 to perform deep leaning shown in FIG. 6A, and use the corrected standard model 900 as the individual model 950. In this case, constrained learning is performed, limiting learning other than that of the adaptive filter block 902 which is related to the parameters of the knob 151 and the slider 152.

As described above, the individual model 950 can be generated by deep learning. In particular, the individual model generation unit 173 preferably corrects the standard model 900, which has been generated by the audio device manufacturer in advance by a first deep learning, by a constrained second deep learning related to parameters, to generate the individual model 950. As a result, the simulation system 1 according to the present embodiment can reduce the computational load when the individual model 950 is generated.

In the embodiment, an example is shown in which the information processing terminal 11 communicates with the server 12, acquires a standard model, and generates an individual model. That is, in the embodiment, the information processing terminal 11 is shown as one example of an audio device simulator. However, the measuring device 14 can, for example, be equipped with a communication function and communicate with the server 12, acquire a standard model, and generate an individual model. In this case, the measuring device 14 also functions as an audio device simulator. Further, the server 12 can transmit a sound signal for measurement to the measuring device 14, receive the measurement result, and generate an individual model based on the measurement result. In this case, the server 12 functions as an audio device simulator.

The description of the embodiment is to be regarded in all respects in the sense of an example, and should not be considered restrictive. The scope of this disclosure is indicated by the claims section and not by the embodiment described above. Furthermore, the scope of this disclosure is intended to include the meaning that is equivalent to that of the claims, as well as all modifications within the scope thereof.

### Effects of the Invention

One embodiment of this disclosure can model the unique sound of each device.

What is claimed is:

1. An audio device simulation method comprising:
acquiring a standard model that models input-output characteristics of an audio device;
setting at least one parameter of a target audio device of the same type as the audio device and measuring input-output characteristics of the target audio device; and
generating an individual model that models input-output characteristics of the target audio device by correcting the standard model using measured input-output characteristics that have been measured.

2. The audio device simulation method according to claim 1, wherein
a plurality of parameters are set in the setting, and
the measuring is performed for each of the plurality of parameters.

3. The audio device simulation method according to claim 1, wherein
the individual model is generated by deep learning using the measured input-output characteristics.

4. The audio device simulation method according to claim 3, further comprising
generating the standard model in advance by a first deep learning, wherein
the individual model is generated by correcting, by a second deep learning, the standard model that has been generated by the first deep learning.

5. The audio device simulation method according to claim 1, wherein
the measuring is performed by using a music signal.

6. The audio device simulation method according to claim 1, wherein
the measuring is performed by using a measurement signal.

7. The audio device simulation method according to claim 1, wherein
the measuring is performed by moving, using a motor, an operator of the target audio device, the operator being configured to receive a change to the at least one parameter.

8. An audio device simulator comprising:
at least one processor configured to
acquire a standard model that models input-output characteristics of an audio device,
measure input-output characteristics of a target audio device of the same type as the audio device, for one or more parameters of the target audio device, and
generate an individual model that models input-output characteristics of the target audio device, by correcting the standard model using measured input-output characteristics that have been measured.

9. The audio device simulator according to claim 8, wherein
the one or more parameters include a plurality of parameters, and
the at least one processor is configured to measure the input-output characteristics for each of the plurality of parameters.

10. The audio device simulator according to claim 8, wherein
the at least one processor is configured to generate the individual model by deep learning using the measured input-output characteristics.

11. The audio device simulator according to claim 10, wherein
the standard model is generated in advance by a first deep learning, and
the at least one processor is configured to generate the individual model by correcting, by a second deep learning, the standard model that has been generated by the first deep learning.

12. The audio device simulator according to claim 8, wherein
the at least one processor is configured to use a music signal to measure the input-output characteristics of the target audio device.

13. The audio device simulator according to claim 8, wherein
the at least one processor is configured to use a measurement signal to measure the input-output characteristics of the target audio device.

14. The audio device simulator according to claim 8, further comprising
a motor configured to move an operator of the target audio device, the operator being configured to receive a change to the one or more parameters.

15. An audio device simulation system comprising:
an audio device simulator configured to acquire a standard model that models input-output characteristics of an audio device; and
a measurement device including at least one processor configured to set at least one parameter of a target audio device of the same type as the audio device and measure input-output characteristics of the target audio device,
the audio device simulator being further configured to generate an individual model that models input-output characteristics of the target audio device, by correcting the standard model using measured input-output characteristics that have been measured.
